(19) United States
(12) Patent Application Publication
(10) Pub. No.: US 2010/0029341 A1
(43) Pub. Date: Feb. 4, 2010

(54) ELECTRONIC DEVICE AND INPUT METHOD THEREOF

(75) Inventor: Chia-Ying LEE, Taipei City (TW)

Correspondence Address: Muncy, Geissler, Olds & Lowe, PLLC, P.O. BOX 1364, FAIRFAX, VA, 22038-1364, US

(73) Assignee: PEGATRON CORPORATION

(21) Appl. No.: 12/510,846

(22) Filed: Jul. 28, 2009

(30) Foreign Application Priority Data
Jul. 30, 2008 (TW) 097128844

(51) Int. Cl. H04B 1/38; G06F 3/02

(52) U.S. Cl. 455/566; 345/168

(57) ABSTRACT

An electronic device has a function of inputting Roman letters. The electronic device includes a display unit, an input unit, and a control unit. The input unit has a plurality of operation directions associated a plurality of direction input signals. The input unit is operated towards one of the operation directions, the input unit generates one of the direction input signals corresponding to a shape character. Each group of the shape characters corresponds to at least one Roman letter. The control unit is coupled to the display unit and the input unit, respectively, and the control unit is used for receiving a group of the direction input signals generated by the input unit to obtain a group of the shape characters corresponding to the group of the direction input signals and to provide at least one Roman letter corresponding to the group of the shape characters for the display unit.

### CROSS REFERENCE TO RELATED APPLICATIONS

This Non-provisional application claims priority under 35 U.S.C. §119(a) on Patent Application No(s). 097128844 filed in Taiwan, Republic of China on Jul. 30, 2008, the entire contents of which are hereby incorporated by reference.

### BACKGROUND OF THE INVENTION

1. Field of Invention

The invention relates to an input method of an electronic device and, more particularly, to an electronic device having an input unit and an input method thereof.

2. Related Art

A general electronic device, such as a mobile phone, a personal digital assistant (PDA) and so on, at least includes numeric keys 0-9, symbolic keys “*” and “#”, and four function keys. The electronic device often includes more than 16 keys, and the keys occupy a lot of space on a front panel. At present, different kinds of the electronic devices trend to have a miniaturized main body and a maximized screen. Therefore, the arrangement and design of the keys are important. If the sizes of the keys decrease or the keys are arranged closely to each other, limited space decreases. However, the keys are inconvenient for users to operate, more particularly, for the users having larger palms.

Since it is necessary to continually operate the keys for inputting messages, the operation of the smaller keys is inconvenient. Although some electronic devices on the market have navigation keys, the navigation keys are just used for controlling direction selections and fail to be used for inputting the text messages.

### SUMMARY OF THE INVENTION

According to one aspect of the invention, the invention discloses an electronic device having a function of inputting Roman letters easily. Each Roman letter can be divided into a group of shape characters. The electronic device includes a display unit, an input unit, and a control unit. The input unit has a plurality of operation directions associated a plurality of direction input signals. The input unit is operated towards one of the operation directions to generate one of the direction input signals corresponding to a shape character. Each Roman letter can be divided into a group of the shape characters corresponding to a group of the direction input signals. The control unit is coupled to the display unit and the input unit, respectively. The control unit is used for receiving a group of the direction input signals generated by the input unit to obtain a group of the shape characters corresponding to the group of the direction input signals, and to provide at least one Roman letter corresponding to the group of the shape characters for the display unit.

According to another aspect of the invention, the invention discloses an input method of an electronic device. The electronic device includes an input unit generating a plurality of direction input signals. Each direction input signal corresponds to a shape character. Each group of the shape characters corresponds to at least one Roman letter. The input method includes the following steps. A group of the direction input signals generated by the input unit is received. According to the group of the direction input signals, a group of the shape characters is obtained. At least one Roman letter corresponding to the group of the shape characters is provided. The at least one Roman letter is displayed.

Thereby, the space occupied by the keys can be saved, facilitating miniaturization of the main body and maximization of the screen. Further, it is convenient for users to input text messages.

These and other features, aspects, and advantages of the present invention will become better understood with regard to the following description, appended claims, and accompanying drawings.

### BRIEF DESCRIPTION OF THE DRAWINGS

FIG. 1A is a schematic diagram showing an electronic device according to a preferred embodiment of the invention;

FIG. 1B is an enlarged diagram showing an input unit of an electronic device according to a preferred embodiment of the invention;

FIG. 2A is a block diagram showing an electronic device according to a preferred embodiment of the invention;

FIG. 2B is another block diagram showing an electronic device according to a preferred embodiment of the invention;

FIG. 3 is a flowchart showing a first input mode of an input method according to a preferred embodiment of the invention; and

FIG. 4 is a flowchart showing a second input mode of an input method according to a preferred embodiment of the invention.

### DETAILED DESCRIPTION OF THE INVENTION

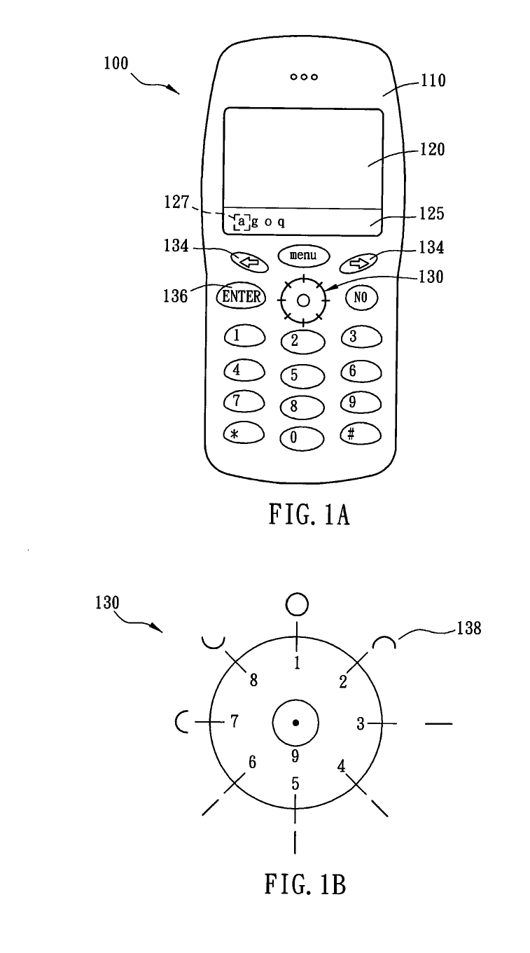

FIG. 1A is a schematic diagram showing an electronic device according to a preferred embodiment of the invention. In the embodiment, the electronic device is a mobile phone. In other embodiments, the electronic device may be a palmtop or handheld portable electronic product such as a PDA and so on. In FIG. 1A, the electronic device 100 has a casing 110, a display unit 120, and an input unit 130. The display unit 120 and the input unit 130 are disposed on the casing 110. The display unit 120 has a selection area 125. Preferably, two direction keys 134 and an enter key 136 are further disposed on the casing 110.

FIG. 1B is an enlarged diagram showing the input unit 130. In FIG. 1B, the input unit 130 has nine direction keys 1 to 9. A user can operate the nine direction keys to generate nine direction input signals S1 to S9, respectively. The nine direction keys correspond to nine shape characters, respectively. The shape characters are obtained by dividing Roman letters. Therefore, a group of the shape characters can correspond to at least one Roman letter. In the embodiment, the Roman letters are small letters. However, in other embodiments, the Roman letters may be capital letters or letters in other language family. The corresponding relation is shown in table 1 as a character-letter look-up table.

TABLE 1

| operation | direction | | |
|---|---|---|---|
| direction | input signal | shape character | letter |
| 1 | S₁ | ◯ | a g o q |
| 2 | S₂ | ∩ | m n |
| 3 | S₃ | - | e f t z |
| 4 | S₄ | \ | v y |
| 5 | S₅ | \| | b h k l p r |
| 6 | S₆ | / | y |
| 7 | S₇ | C | c d s |
| 8 | S₈ | ∪ | u w x |
| 9 | S₉ | · | i j |

From the above table, the corresponding relation of each operation direction, each direction input signal, each shape character, and each small letter is shown. For example, the operation direction 1 corresponds to the direction input signal S₁, the direction input signal S₁ corresponds to the shape character O, and the shape character O corresponds to the letters a, g, o, and q.

In the embodiment, preferably, the input unit 130 may have a character diagram 138 including nine shape characters. In FIG. 1B, the shape characters are shown on the corresponding operation direction, respectively. The character diagram 138 can facilitate inputting needed letters. In other embodiment, the input unit 130 may not show the character diagram 138.

In the embodiment, the corresponding relation between the shape character and the letter is obtained by dividing the letter according to a stroke sequence. In detail, the letter is divided according to the stroke sequence. If the shape of a first stroke is similar to that of a shape character, the letter corresponds to the shape character. A shape character may only correspond to a letter. For example, the shape character/may correspond to the letter y. A shape character may correspond to several letters. For example, the shape character O may correspond to the letters a, g, o, and q. The corresponding relation of each operation direction, each direction input signal, each shape character, and each small letter and the shapes of the shape characters are not limited to table 1, and they can be determined by software designers.

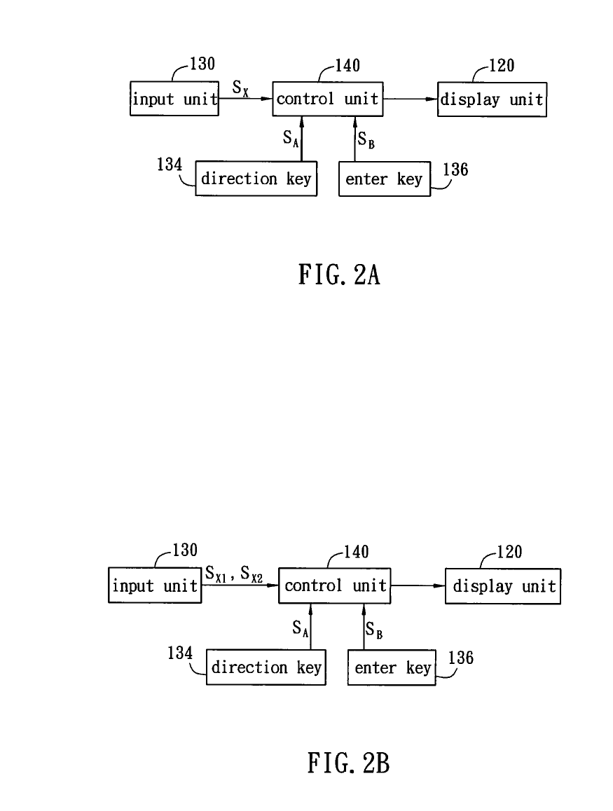

FIG. 2A and FIG. 2B are block diagrams showing an electronic device according to a preferred embodiment of the invention. In FIG. 2A, a control unit 140 is coupled to the display unit 120 and the input unit 130, respectively. The input unit 130 generates a direction input signal S_{X} and the control unit 140 receives the direction input signal S_{X}. According to the direction input signal S_{X}, the control unit 140 obtains and provides a shape character corresponding to the direction input signal S_{X}. Further, the control unit 140 provides at least one Roman letter corresponding to the shape character for the display unit 120, thus displaying the at least one Roman letter at the display unit 120.

The character-letter look-up table, that is, the table 1, can be built in the control unit 140. Thereby, the control unit 140 uses the built-in character-letter look-up table to find out at least one letter corresponding to the shape character.

The direction keys 134 are coupled to the control unit 140 and generate an input selection signal S_{A} for selecting a letter from the at least one letter corresponding to the shape character. The enter key 136 is coupled to the control unit 140 and generates an input confirmation signal S_{B} to the control unit 140 for confirming input of the at least one letter.

In FIG. 2B, the control unit 140 can be further used to receive a group of the direction input signals generated by the input unit 130, such as the direction input signals S_{X1} and S_{X2}. According to the group of the direction input signals, the control unit 140 obtains a group of the shape characters corresponding to the group of the direction input signals and provides at least one Roman letter corresponding to the group of the shape characters for the display unit 120.

In other embodiments, a group of the direction input signals may include two or more direction input signals.

Table 2 is another character-letter look-up table. Table 2 shows the corresponding relation of each group of the direction input signals, each group of the shape characters, and each letter in the embodiment. In table 2, a group of the direction input signals correspond to a group of the shape characters, and each group of the shape characters corresponds to at least one Roman letter. For example, a group of the direction input signals S₇ and S₅ may correspond to a group of the shape characters C and |, and the group of the shape characters C and | may correspond to the letter d.

TABLE 2

| | | | | | | | |
|---|---|---|---|---|---|---|---|
| operation | 14 | 51 | 7 | 75 | 37 | 32 | 158 |
| direction | | | | | | | |
| direction | S₁S₄ | S₅S₁ | S₇ | S₇S₅ | S₃S₇ | S₃S₂ | S₁S₅S₈ |
| input | | | | | | | |
| signal | | | | | | | |
| shape | ◯\ | \|◯ | C | C\| | -C | -∩ | ◯\|∪ |
| character | | | | | | | |
| letter | a | b | c | d | e | f | g |
| operation | 52 | 95 | 958 | 564 | 5 | 22 | 2 |
| direction | | | | | | | |
| direction | S₅S₂ | S₉S₅ | S₉S₅S₈ | S₅S₆S₄ | S₅ | S₂S₂ | S₂ |
| input | | | | | | | |
| signal | | | | | | | |
| shape | \|∩ | ·\| | ·\|∪ | \|/\ | \| | ∩∩ | ∩ |
| character | | | | | | | |
| letter | h | i | j | k | l | m | n |
| operation | 1 | 551 | 15 | 56 | 78 | 35 | 8 |
| direction | | | | | | | |
| direction | S₁ | S₅S₅S₁ | S₁S₅ | S₅S₆ | S₇S₈ | S₃S₅ | S₈ |
| input | | | | | | | |
| signal | | | | | | | |
| shape | ◯ | \|\|◯ | ◯\| | \|/ | C∪ | -\| | ∪ |
| character | | | | | | | |
| letter | o | p | q | r | s | t | u |
| operation | 46 | 88 | 82 | 466 | 363 | | |
| direction | | | | | | | |
| direction | S₄S₆ | S₈S₈ | S₈S₂ | S₄S₆S₆ | S₃S₆S₃ | | |
| input | | | | | | | |
| signal | | | | | | | |
| shape | \/ | ∪∪ | ∪∩ | \// | -/- | | |
| character | | | | | | | |
| letter | v | w | x | y | z | | |

The corresponding relation of the combination of the shape characters and the letter is obtained by dividing the letter according to a stroke sequence. In detail, each letter is divided and arranged according to the stroke sequence. If the strokes correspond to a plurality of shape characters in turn, that is, the strokes are similar to a plurality of shape characters, the letter corresponds to the combination of the shape characters. In the embodiment, the corresponding relation and the shapes of the shape characters are not limited to table 2, and they may be determined by the software designers.

The character-letter look-up table as shown in table 2 can also be built in the control unit 140 to facilitate looking up the letters corresponding to the combination of the divided letters for the control unit 140.

In the embodiment, in FIG. 1A, the electronic device 100 further has an automatic input function. After a letter menu is displayed at the display unit 120 for a predetermined time, the control unit 140 automatically generates an input confirmation signal to confirm the input of at least one letter.

The embodiment of the invention further provides an input method. The input method mainly includes two input modes. In a first input mode, according to a direction input signal, the needed Roman letter is input. In a second input mode, according to a group of the direction input signals, the needed Roman letter is input. In the embodiment, the Roman letters are small letters. In other embodiments, the Roman letters may be capital letters or letters in other language family.

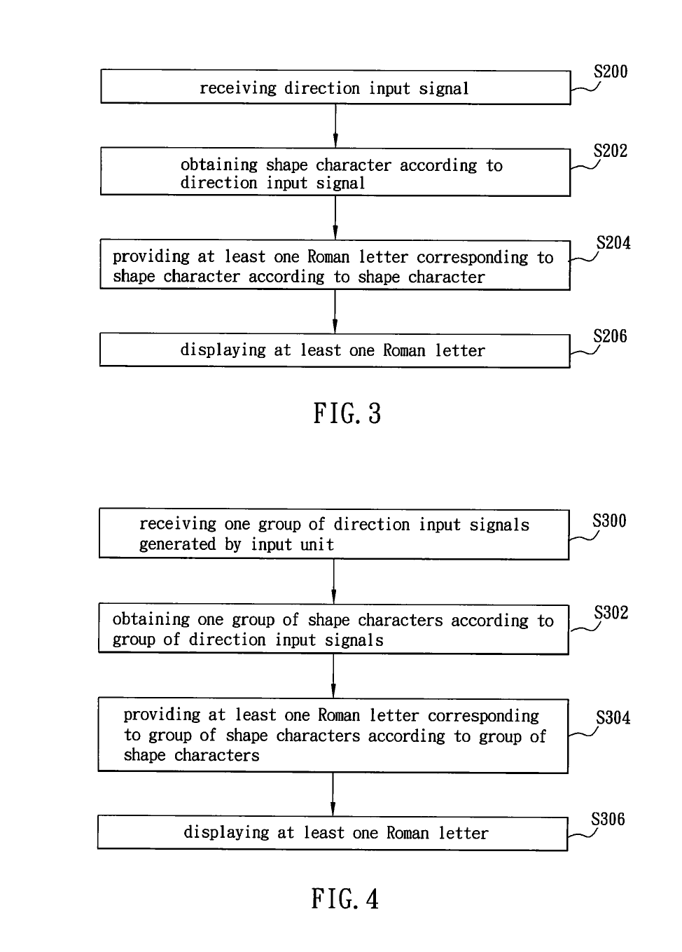

First, the first input mode is described. Please refer to FIG. 1A, FIG. 1B, FIG. 2A, and FIG. 3 at the same time. FIG. 3 is a flowchart showing the first input mode of the input method according to a preferred embodiment of the invention.

In FIG. 3, when a user operates the input unit 130 towards an operation direction, the input unit 130 generates a direction input signal S_{X}, and the control unit 140 receives the direction input signal S_{X} (step S200). Then, according to the direction input signal S_{X}, the control unit 140 obtains a shape character corresponding to the direction input signal S_{X} (step S202). Further, the control unit 140 provides at least one Roman letter corresponding to the shape character for the display unit 120 (step S204). The at least one Roman letter is displayed at the display unit 120 (step S206).

In step S202 and S204, the control unit 140 can use a look-up table to obtain at least one letter corresponding to the shape character. The table 1 is taken for example. When the user operates the input unit 130 towards the operation direction 1, a direction input signal S₁ is generated, and the control unit 140 receives the direction input signal S₁. Then, according to the direction input signal S₁, the control unit 140 looks up the table 1 and finds that the direction input signal S₁ corresponds to the shape character O and the shape character O corresponds to the small letters a, g, o, and q. The display unit 120 displays a letter menu including the small letters a, g, o, and q at the selection area 125.

After step S206, after the user presses the enter key 136 for generating an input confirmation signal S_{B}, the control unit 140 receives the input confirmation signal S_{B} to complete the input. For example, in FIG. 1A, a cursor 127 may default to the first letter. At that moment, when the user presses the enter key 136, the control unit 140 receives an input confirmation signal S_{B} to complete the input of the small letter a.

The user can also operate the direction keys 134 to make the direction keys 134 generate an input selection signal S_{A}. The control unit 140 receives the input selection signal S_{A} to select one letter from the at least one letter corresponding to the shape character. For example, in FIG. 1A, the cursor 127 may default to the first letter a. At that moment, when the user presses the direction key 134, the cursor 127 moves rightward to the letter g. When the user represses the enter key 136, the control unit 140 receives an input confirmation signal S_{B} to complete the input of the small letter g.

In other embodiments, the cursor 127 may not be used. The cursor 127 is just used to facilitate understanding of the condition in use for the users, thereby achieving a fast input. In other embodiments, the functions of the direction key and the enter key may be achieved by other input elements. Therefore, the forms of the direction key and the enter key are not limited thereto.

The input method has a second input mode according to a preferred embodiment of the invention. That is, according to a group of the direction input signals, the needed letter is input. In the embodiment, the group of the direction input signals includes two direction input signals. In other embodiments, the group of the direction input signals may include more than two direction input signals. Please refer to FIG. 1A, FIG. 1B, FIG. 2B, and FIG. 4 at the same time. FIG. 4 is a flowchart showing the second input mode of the input method according to a preferred embodiment of the invention.

First, when the user presses the input unit 130 continually towards different operation directions, the input unit 130 generates a group of the direction input signals, and the control unit 140 receives the group of the direction input signals (step S300). Then, the control unit 140 obtains a group of the shape characters corresponding to the group of the direction input signals according to the group of the direction input signals (step S302). The control unit 140 provides at least one Roman letter corresponding to the group of the shape characters according to the group of the shape characters (step S304). Finally, the display unit 120 displays the at least one Roman letter (step S306).

After the display unit 120 displays the at least one letter, when the user presses the enter key 136, the control unit 140 receives an input confirmation signal S_{B} generated by the enter key 136 to complete the input of a letter.

In this input mode, the user uses the direction keys 134 to select the letter. The steps are the same as the corresponding steps in the first input mode which are described above. Therefore, they are not described in detail for a concise purpose.

In addition, in step S302 and S304, the control unit 140 also uses a look-up table to obtain the at least one letter corresponding to the group of the shape characters.

Table 2 is taken for example. When the user operates the input unit 130 towards an operation direction 1, the control unit 140 can receive a direction input signal S₁ generated by the input unit 130. If the user continually operates the input unit 130 towards an operation direction 5, the input unit 130 generates a direction input signal S₅, and the control unit 140 receives the direction input signal S₅. Thus, the control unit 140 receives a group of the direction input signals including the direction input signals S₁ and S₅. According to the table 2, the control unit 140 can obtain a group of the shape characters including the shape characters O and | according to the direction input signals S₁ and S₅. According to the group of the shape characters, the control unit 140 provides the small letter q corresponding to the group of the shape characters for the display unit 120. The display unit 120 displays the small letter q at the selection area 125.

In addition, in step S304, the group of the shape characters can totally or partly correspond to the letter.

For example, according to the table 2, the letter r corresponds to the group of the shape characters |/, and the group of the shape characters totally correspond to the letter r. The letter k corresponds to the group of the shape characters |/\. The group of the shape characters |/\ has a part which is the same as the shape characters |/, and the same part has the same sequence. Therefore, the letter k partly corresponds to the shape characters |/. That is, when the group of the shape characters | and / is taken for example, in step S306, the display unit 120 may display the letters r and k at the same time for selection.

In other embodiments, the display unit 120 can only display the letters totally corresponding to a group of the shape characters. If the group of the shape characters totally corresponds to more than one letter, the letters can be displayed at the same time for the users to select. The design may be determined by the software designers. Therefore, it is not limited thereto.

In the embodiment, after the display unit 120 displays at least one letter for a predetermined time, if the control unit 140 does not receive the input confirmation signal S_{B}, the control unit 140 automatically generates the input confirmation signal S_{B} to input the letter where the cursor 127 is located. In other embodiments, the above function may not be needed.

In the embodiment, the input method can further include a convenient input mode. For example, according to the table 2, if a user wants to input a small letter k, the operation directions 5, 6, and 4 may be operated on the input unit 130. In the convenient input mode, the user only needs to operate the input unit 130 towards the operation directions 5 and 7, and the small letter k can be displayed on the display area. The operation is the same as the above. Therefore, it is not described for a concise purpose. Table 3 is shown in detail hereinafter.

TABLE 3

| | | | | | | |
|---|---|---|---|---|---|---|
| operation direction | 18 | 98 | 57 | 55 | 66 | 36 |
| direction input signal | S₁S₈ | S₉S₈ | S₅S₇ | S₅S₅ | S₆S₆ | S₃S₆ |
| shape character | ◯∪ | ·∪ | \|C | \|\| | // | -/ |
| letter | g | j | k | p | y | z |

The part letters in table 2 can have the corresponding relation in table 3 to facilitate quickly inputting letters. The corresponding relation of each operation direction, each direction input signal, each shape character, and each small letter is not limited to the table 2 or the table 3, and it can be determined by the software designers.

In another embodiment of the invention, the input unit may be an eight-direction input unit. The eight-direction key is similar to the nine-direction key in the above embodiment. The difference is that the eight-direction key does not have an intermediate operation direction. That is, the eight-direction key does not have an intermediate key, or the intermediate key is used as an enter key or any other keys. The input method of the electronic device having the eight-direction key is similar to that of the electronic device having the nine-direction key. Since the shape characters corresponding to the individual letters change, the input mode changes. Table 4 is shown hereinafter.

TABLE 4

| operation | direction | shape | |
|---|---|---|---|
| direction | input signal | character | letter |
| 5 | S₅ | \| | b h k l p r i j |

According to the table 1, when the input unit 130 is operated towards the operation direction 5, the letters b h k l p r are displayed at the display area. If the input unit 130 is not operated towards the operation direction 9, the letters i and j can correspond to the shape character |. That is, after the input unit is operated towards the operation direction 5, the display unit displays b h k l p r i j as shown in table 4. The software designers can determine that the operation direction corresponds to other shape characters.

When there is no operation direction 9, the combination of the shape characters corresponding to the individual letters also needs changes. The changing part is shown in table 5.

TABLE 5

| | | |
|---|---|---|
| operation direction | 5 | 58 |
| direction input signal | S₅ | S₅S₈ |
| shape character | \| | \|∪ |
| letter | i | j |

To sum up, according to the electronic device and the input method of the embodiment of the invention, the users input the needed letters comfortably and quickly. Further, the electronic device can obtain a minimized main body and a maximized screen.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device having a function of inputting Roman letters, the electronic device comprising:
a display unit;
an input unit having a plurality of operation directions associated a plurality of direction input signals, the input unit is operated towards one of the operation directions to generate one of the direction input signals, each direction input signal corresponding to a shape character, each Roman letter capable of being divided into a group of the shape characters corresponding to a group of the direction input signals; and
a control unit coupled to the display unit and the input unit, respectively, the control unit receiving a group of the direction input signals generated by the input unit to obtain a group of the shape characters corresponding to the group of the direction input signals, and providing at least one Roman letter corresponding to the group of the shape characters for the display unit.

2. The electronic device according to claim 1, wherein the control unit has a built-in character-letter look-up table for providing the at least one Roman letter corresponding to the group of the shape characters.

3. The electronic device according to claim 1, further comprising a plurality of direction keys coupled to the control unit, the direction keys generating a plurality of input selection signals for selecting a Roman letter from the at least one Roman letter corresponding to the group of the shape characters.

4. The electronic device according to claim 1, further comprising an enter key coupled to the control unit, the enter key generating an input confirmation signal to the control unit for confirming input of one Roman letter of the at least one Roman letter.

5. The electronic device according to claim 1, wherein the input unit has a character diagram having the shape characters.

6. The electronic device according to claim 1, wherein after the display unit displays the at least one Roman letter corresponding to the group of the shape characters for a predetermined time, the control unit automatically generates an input confirmation signal for confirming input of a Roman letter of the at least one Roman letter.

7. An input method of an electronic device, the electronic device including an input unit generating a plurality of direction input signals, each direction input signal corresponding to a shape character, and each group of the shape characters corresponding to at least one Roman letter, the input method comprising the steps of:
receiving a group of the direction input signals generated by the input unit;
obtaining a group of the shape characters according to the group of the direction input signals;
providing at least one Roman letter corresponding to the group of the shape characters; and
displaying the at least one Roman letter.

8. The input method according to claim 7, further comprising the step of:
using a look-up table to find out the at least one Roman letter.

9. The input method according to claim 7, further comprising the step of:
receiving an input confirmation signal.

10. The input method according to claim 7, further comprising the step of:
receiving an input selection signal for selecting a Roman letter from the at least one Roman letter.

11. The input method according to claim 7, further comprising the step of:
generating a letter menu having the at least one Roman letter.

12. The input method according to claim 11, further comprising the step of:
receiving an input selection signal, wherein the input selection signal is used for selecting a Roman letter from the letter menu.

13. The input method according to claim 7, wherein in the step of displaying the at least one Roman letter, after the at least one Roman letter is displayed for a predetermined time, the electronic device automatically generates an input confirmation signal.
